(19) United States
(12) Patent Application Publication
(10) Pub. No.: US 2008/0120219 A1
(43) Pub. Date: May 22, 2008

(54) Opportunity-based ordering platform system

(76) Inventor: Fu-Liang Chen, Dounan Township (TW)

Correspondence Address: John G. Chupa;Law Offices of John Chupa & Associates, P.C., Suite 50, 28535 Orchard Lake Road, Farmington Hills, MI, 48334, US

(21) Appl. No.: 11/724,134

(22) Filed: Mar. 14, 2007

(30) Foreign Application Priority Data
Nov. 22, 2006 (TW) 095143110

(51) Int. Cl. G06Q 40/00

(52) U.S. Cl. 705/37

(57) ABSTRACT

The present invention relates to an opportunity-based ordering platform system. By applying the steps of the present invention, the seller's capability is more competitive and the buyers have an opportunity to purchase goods with a lower price. The system comprises a red tag goods bidding platform, a blue tag goods redeem platform, a membership system, and a charging system. Wherein, the red tag goods bidding platform mainly provides the product catalogs, the goods bidding closing time, the interval number of the good's bidding, and the red tag points that should be deducted when placing the bid, as well as the function for the buyers to place the bid. After the goods bidding is closed, the system searches and selects a bid order that has a unique bid interval number and assigns the owner of that bid order as both the bid winner and the lucky draw winner. The lucky draw winner can purchase the goods with only 10% of the product's current market price. For those users that had placed their bids on the red tag area's goods but do not win the bid, their red tag points on the bid are completely transferred to the blue tag points, which can be used to redeem the goods with equivalent value on the blue tag goods redeem platform later. The blue tag goods redeem platform mainly provides the product catalogs, the blue tag points that is required to redeem the goods, and the function for the buyers to redeem the goods. The red tag points are obtained from the charging system, in which the stored cash amount is transferred to the red tag points, and the red tag points can be directly applied on the red tag goods bidding platform and the blue tag goods redeem platform.

### BACKGROUND OF THE INVENTION

1. Field of the Invention

The present invention relates to an opportunity-based ordering platform system. By applying the steps of the present invention, the seller's capability is more competitive and the buyers have an opportunity to purchase goods with a lower price. The system comprises a goods bidding platform, a goods redeem platform, a membership system, and a charging system. With this working model, an opportunity-based ordering platform system with interaction transaction between the red tag goods bidding service and the blue tag goods redeem service is achieved.

2. Description of the Related Art

The requirements of the current buyers had become increasingly diverse and personalized, thus the traditional product marketing method is not able to fulfill the requirements of the sellers in the current market. Recently, thanks to the fast development of the Cable TV and Internet, the new services such as TV shopping, Internet shopping, One dollar bid, Internet auction, and Free goods are provided to the market, the management of these new services is described in greater detail below:

1. The goods sold in the TV shopping channel normally have a fixed price. Each goods has its own selling time and quantity limitation, if the buyer wants to buy the product, the product should be sold with the price tagged on the goods.

2. The goods sold in the Internet shopping website also have a fixed price. If the buyer wants to buy the product, the product is also sold with the price tagged on the goods.

3. The price of the goods sold with the one dollar bid method starts from $1. During the valid bidding time, all buyers can place their bid. However, the offered bidding price must be higher than the previous bidding price. This bidding process is continuously running until the bid is over. Then, the last bidder with the highest price wins the bid and should purchase the goods with the final bidding price he/she offers. Normally, the price of the goods bought by the buyer through this method is similar to the current market price.

4. There are two different modes usually used in Internet shopping, one is with the reserved price and another is without the reserved price. During the selling time, all buyers can place their bid. However, the offered bidding price must be higher than the previous bidding price. This bidding process is continuously running until the bid is over. Then, the last bidder with the highest price wins the bid and should purchase the goods with the final bidding price he/she offers. Normally, the price of the goods bought by the buyer through this method is very similar to or even higher than the reserved price.

5. For the marketing of free goods, it is very common that the system will request the buyer to pay the shipping and handling charge when the buyer requests to receive the free goods. Normally, the value of the free goods is not in the high end range.

In summary, the final price of the goods paid by the buyers is similar to the product's current market price, and the buyers have no opportunity to purchase the goods with a price much lower than the current market price. Whereas, the sellers who just joined the market and the dealers with a lower capital will lose their competition capability on the price due to the smaller amount of goods purchased from the source, this is because the large wholesaler has a lower purchased price for the same goods.

### SUMMARY OF THE INVENTION

In order to resolve the aforementioned disadvantages, after a long time of dedication on research and experiments, the inventor of the present invention had developed an “opportunity-based ordering platform system” which may contribute to the current market.

The main objective of the present invention is to allow the buyers to have the opportunity to purchase their desired goods with a price much lower than the current market price, so as to improve the sellers' competition capability.

It is an objective of the present invention to provide an opportunity-based ordering platform system. The system comprises a goods bidding platform, a goods redeem platform, a membership system, and a charging system.

The goods bidding platform mainly provides the product catalogs, the goods bidding closing time, the goods purchase price, the interval number of the good's bidding, and the red tag points that should be deducted when placing the bid, as well as the function for the buyers to place the bid. The buyers can freely select their desired goods and place their bid order with the interval number. The buyer's red tag points are deducted each time when a bid order is placed. The buyer is allowed to repeatedly place their bid and the red tag points are deducted each time when the bid is placed. After the good's bidding is closed, the system searches and selects a bid order that has a unique bid interval number and assigns the owner of that bid order as the lucky draw winner. The lucky draw winner can purchase the goods with only 10% of the product's current market price.

The interval number is a serial number composed of natural numbers, e.g. a number between 1 to 100. The unique bidder is the only bidder that had placed the bid with the interval number. If there is no unique bidder for the goods, the system will choose a bidder that had been placed earliest between two interval numbers as the winner. If it is still not possible, the system will choose a bidder that had been placed earliest among three interval numbers as the winner, and so on. Thus, each good will have one bid winner.

The red tag points corresponding to the goods of the buyer who does not win the bid are completely transferred to the blue tag points, which can be used to redeem the goods on the blue tag goods redeem platform later.

The blue tag goods redeem platform mainly provides the product catalogs and the blue tag points required to redeem the goods, as well as the function for the buyer to redeem the goods.

The membership system mainly records the member's information, which includes the member's basic information, account number, password, red tag points, blue tag points, information related to the bid placed on the red tag goods service platform, and information related to the redeeming on the blue tag goods service platform.

The charging system is mainly for purchasing the red tag points and for transferring the stored cash amount to the red tag points for the buyers. Wherein, the red tag points can be directly applied on the red tag goods bidding platform and the blue tag goods redeem platform. The red tag points have the same value as the blue tag points, but the blue tag points cannot be used on the red tag goods service platform.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic configuration diagram of an opportunity-based ordering platform provided by the present invention.

FIG. 2 is a schematic diagram of an integrated platform including the red tag area (i.e. the goods bidding platform) and the blue tag area (i.e. the goods redeem platform) provided by the present invention.

FIG. 3 is a schematic configuration diagram of a membership system provided by the present invention.

FIG. 4 is a schematic configuration diagram of a charging system provided by the present invention.

### DETAIL DESCRIPTION OF THE PREFERRED EMBODIMENTS

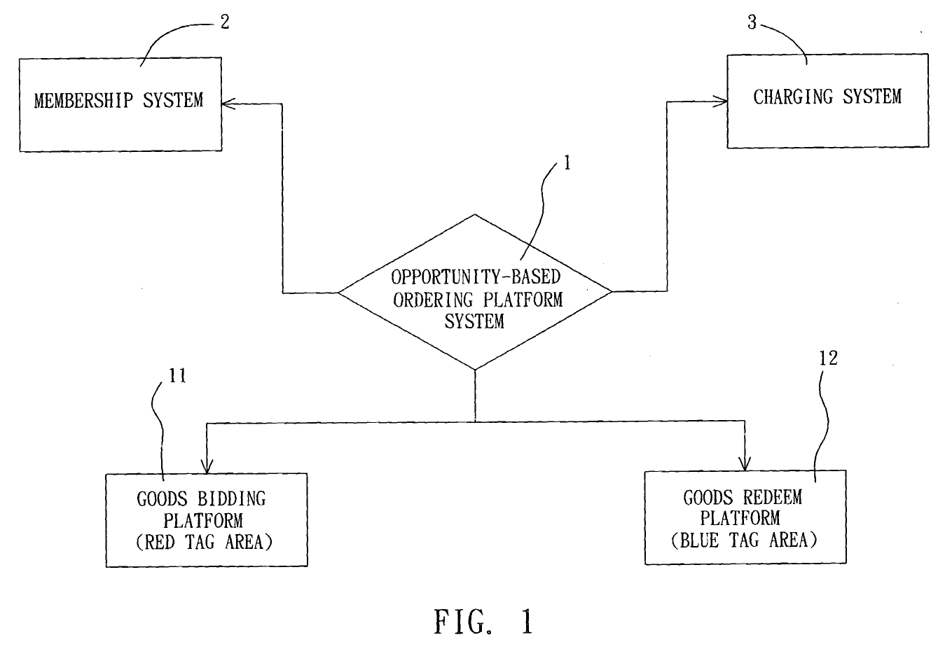

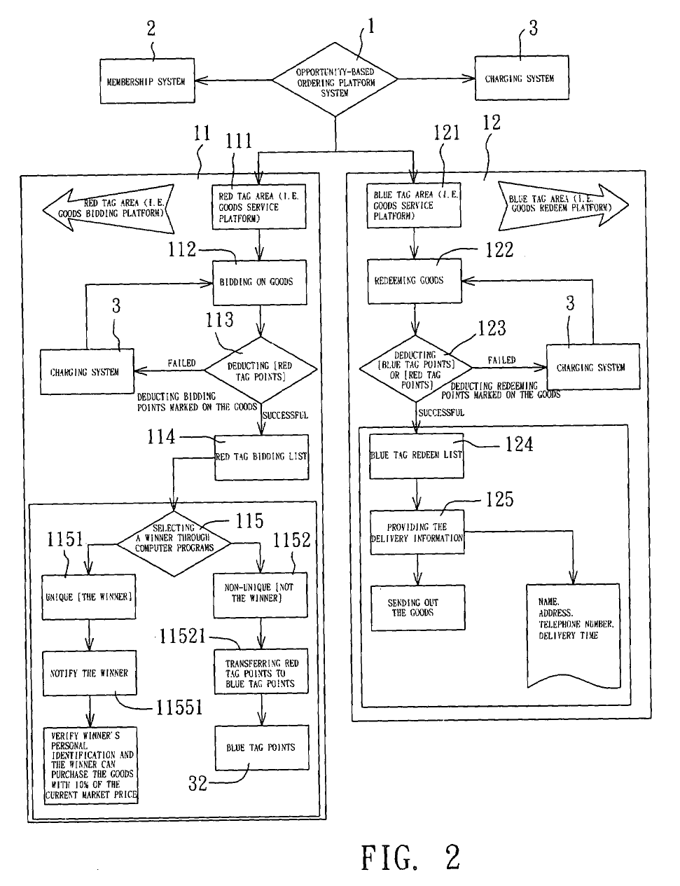

The present invention relates to an opportunity-based ordering platform system. Referring to FIG. 1 and 2, the system is configured as an opportunity-based ordering platform system 1, which comprises a red tag goods bidding platform 11, a blue tag goods redeem platform 12, a membership system 2, and a charging system 3.

The red tag area goods bidding platform 11 mainly comprises: a red tag area goods service platform 111; providing the product catalogs, the goods bidding closing time, the interval number of the good's bidding and the red tag points that needs to be deducted; for the buyer to place the bid order 112; after the buyer had placed the bid order on the goods 112, the system deducts the bid's points (i.e. the red tag points) 113; after it is successfully deducted, a red tag bidding list 114 is generated; and if it fails to deduct, the process goes to the charging platform 3 to purchase the red tag points 31. When the good's bid is over, a winner selection operation is performed 115, if a unique interval number of the good's bidding is revealed 1151, the system will notify the winner 11511, and after being verified with the personal identification, the winner can purchase the goods with a price of 10% of the product's current market price. For all bid orders with the interval number rather than the unique interval number 1152, the red tag points are transferred to the blue tag points 11521 and the blue tag points 32 are generated. The blue tag area goods redeem platform 12 mainly comprises: a blue tag area goods service platform 121; providing the product catalogs and the blue tag points 32 required to redeem the goods; after the buyer had redeemed the goods 122, the system will deduct the redeem points (i.e. the blue tag points) 123; if it is successfully deducted, a blue tag redeem list 124 is generated; and if it fails to deduct, the process goes to the charging platform 3 to purchase the red tag points 31. In addition, the red tag points 31 may be also used as the deducted redeem points (i.e. the blue tag points) on the blue tag area goods redeem platform 12. Wherein, the red tag points 31 have the same value as the blue tag points 32, but the blue tag points 32 cannot be used on the red tag goods bidding platform 11.

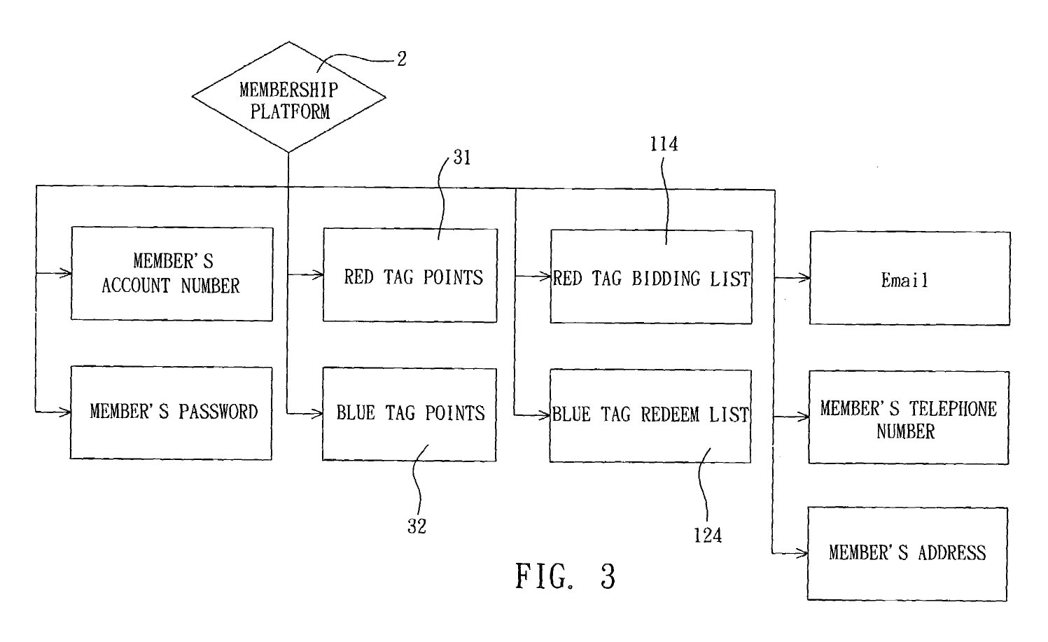

Referring to FIG. 3, the membership system 2 mainly records the member's account number, password, basic information, the red tag points 31, the blue tag points 32, the red tag bidding list 114, and the blue tag bidding list 124.

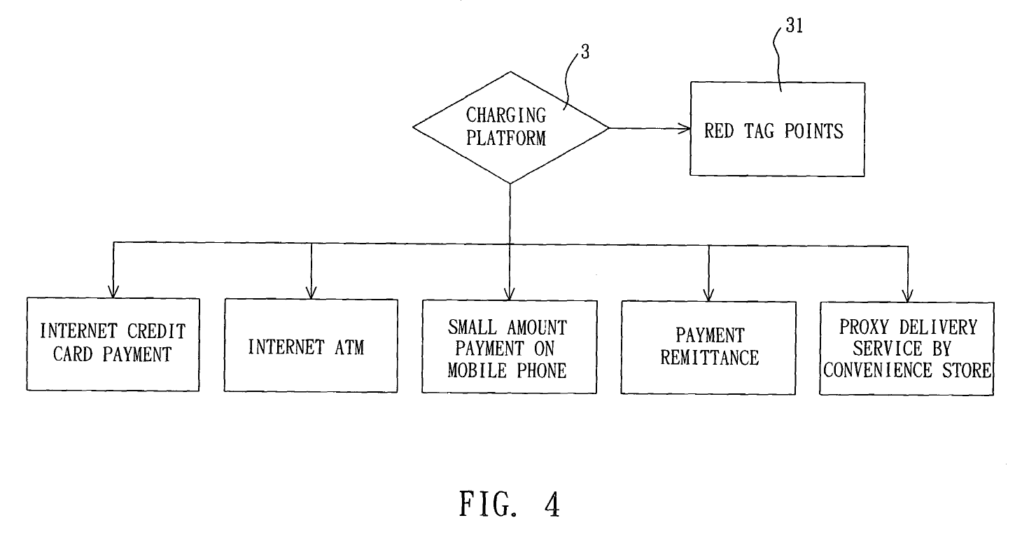

Referring to FIG. 4, the charging system 3 mainly transfers the buyer's stored cash amount to the red tag points 31. The red tag points 31 may be used as the bidding points of the goods with the interval number on the goods bidding platform (i.e. the red tag area) 11. Additionally, both the red tag points 31 and the blue tag points 32 can be used on the goods redeem platform (i.e. the blue tag area) 12.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. An opportunity-based ordering platform system, comprising:
a goods bidding platform, mainly providing a product catalog, a goods bidding closing time, a goods purchase price, an interval number of a good's bidding, as well as a function for a buyer to place a bid order before said bid is over; after said bid is over, selecting a winner of said bid, and transferring a plurality of red tag points corresponding to said bid of said buyer to a plurality of blue tag points that can be used on a goods redeem platform;
said goods redeem platform, mainly providing said product catalog, said blue tag points required to redeem said goods, and a function for said buyer to redeem said goods;
a membership system, mainly recording a member's account number, password, basic information (e.g. telephone number, address, e-mail address), said red tag points, said blue tag points, a red tag bidding list, and a blue tag redeem list; and
a charging system, mainly for obtaining said red tag points, which can be used in placing said bid on said good's bidding platform or said goods redeem platform.

2. The opportunity-based ordering platform system as claimed in claim 1, wherein said good's bidding platform mainly provides said product catalog, said good's bidding closing time, said goods purchase price, said interval number of said good's bidding, and said red tag points that should be deducted when placing said bid, as well as said function for said buyer to place said bid order before said bid is over; after said bid is over, said winner selection system selects a bid order with an internal number of a unique bidder as both a bid winner and a lucky draw winner who can purchase said goods with only 10% of said product's current market price, for those users that had placed their bids on said goods but do not win said bid, said red tag points on said bid are completely transferred to said blue tag points, which can be used to redeem said goods on said blue tag goods redeem platform later.

3. The opportunity-based ordering platform system as claimed in claim 2, wherein said bidding is an operation that said buyer places said bid order on said goods, said buyer can place said bid order with said interval number on the same goods, and said red tag points for said goods are deducted by said system each time when said bid order is placed.

4. The opportunity-based ordering platform system as claimed in claim 2, wherein said winner selection system selects said bid order with said interval number of said unique bidder, here said interval number is a serial number composed of natural numbers but it may also not necessarily be a serial number, and said interval number of said unique bidder is a number during the interval when there is only one buyer that had placed said bid order.

5. The bid order of said unique bidder as claimed in claim 4 is owned by the unique buyer who placed said bid order with said interval number, then said buyer is assigned as a winner of said bid and can purchase said goods with 10% of said product's current market price.

6. The unique bidder as claimed in claim 5, wherein if it is not possible to find a unique bidder from said bid orders with said interval number, said system selects the earliest bid order among said bid orders with two interval numbers and assign an owner of said bid order as a bid winner, who can purchase said goods with a price much lower than said product's current market price, if it is still not possible, said system selects the earliest bid order among said bid orders with three interval numbers and assign an owner of said bid order as a bid winner, and so on, thus a bid order with the lowest interval number and had been placed earliest will be the bid winner of said goods.

7. The bid winner as claimed in claim 2 can purchase said goods with a price of only 10% of said product's current market price.

8. The bid winner as claimed in claim 5 can purchase said goods with a price of only 10% of said product's current market price.

9. The opportunity-based ordering platform system as claimed in claim 1, wherein said goods redeem platform mainly provides said product catalog and said blue tag points required to redeem said goods for said buyer to select and redeem said goods, as long as said buyer has sufficient redeemable blue tag points or red tag points, said buyer can acquire said goods.

10. The opportunity-based ordering platform system as claimed in claim 1, wherein said membership system mainly records said member's account number, password, basic information (e.g. telephone number, address, e-mail address), said owned red tag points, said owned blue tag points, said red tag bidding list, and said blue tag redeem list, wherein said red tag points are obtained from said charging system, and said blue tag points are transferred from said bidding points (i.e. said red tag points) that do not win said bid, here said red tag bidding list is a record of said member placing bid on said good's bidding platform, and said blue tag redeem list is a record of said member redeeming said goods on said goods redeem platform.

11. The opportunity-based ordering platform system as claimed in claim 1, wherein said charging system (e.g. through an Internet credit card order, an Internet ATM, a small amount payment on mobile phone, a payment remittance, a proxy delivery service by convenience store, etc.) transfers said stored cash amount to said red tag points, which can be used on said goods bidding platform and said goods redeem platform.
